(19) United States
(12) Patent Application Publication
(10) Pub. No.: US 2025/0392606 A1
(43) Pub. Date: Dec. 25, 2025

(54) SYSTEMS AND METHODS FOR AUTOMATICALLY DIVERTING DATA TRANSMISSION FROM COMPROMISED PROCESSING COMPONENTS

(71) Applicant: BANK OF AMERICA CORPORATION, Charlotte, NC (US)

(72) Inventors: Sneha Padiyar, Mumbai (IN); Maneesh Kumar Sethia, Hyderabad (IN); Mahek Zahid Suleman, Mumbai (IN); Rashmi Tripathi, Lucknow (IN)

(73) Assignee: BANK OF AMERICA CORPORATION, Charlotte, NC (US)

(21) Appl. No.: 18/752,090

(22) Filed: Jun. 24, 2024

(51) Int. Cl. H04L 9/40

(52) U.S. Cl. CPC H04L 63/1416

(57) ABSTRACT

Systems, computer program products, and methods are described herein for automatically diverting data transmission from compromised processing components. The present invention is configured to identify a processing component associated with a data transmission; determine, by an artificial intelligence engine, whether an anomaly is present in the processing component based on identifying at least one of central processing unit utilization, data transmission data, or a negative internet protocol address; determine, by a machine learning model, whether the data transmission matches at least one pre-identified compromised data transmission pattern; determine whether to transmit the data transmission based on the determination whether the anomaly is present in the processing component or the determination whether the data transmission matches at least one pre-identified compromised data transmission pattern; and generate an alert interface component based on said determinations of the presence of anomalies or pre-identified compromised data transmission patterns.

### FIELD OF THE INVENTION

The present invention embraces a system for automatically diverting data transmission from compromised processing components.

### BACKGROUND

Processing components, especially those that are configured to perform and process data transmissions to detect potential malfeasant activity or misappropriation activity within the data transmissions, can be difficult to detect whether the processing components have been compromised or are functioning improperly. Additionally, and further to this identified issue, the data transmissions intended for these processing components must be dynamically, efficiently and automatically diverted to other, valid processing components. Therefore, a need exists for a system, computer program product, or computer implemented method that can dynamically, efficiently, securely, and automatically determine whether a processing component has been compromised and divert data transmissions without allowing for the breach of the data within those data transmissions.

Applicant has identified a number of deficiencies and problems associated with determining when processing components are compromised and diverting data that is to be processed by those compromised processing components. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for automatically diverting data transmissions from compromised processing components is provided. In some embodiments, the system may comprise: a processing device; a non-transitory storage device containing instructions when executed by the processing device, causes the processing device to perform the steps of: identifying a processing component associated with a data transmission; determining, by an artificial intelligence (AI) engine, whether an anomaly is present in the processing component based on identifying at least one of central processing unit utilization, data transmission data, or a negative internet protocol (IP) address; determining by a machine learning model, whether the data transmission matches at least one pre-identified compromised data transmission pattern; determining whether to transmit the data transmission based on the determination whether the anomaly is present in the processing component or the determination whether the data transmission matches at least one pre-identified compromised data transmission pattern; and generating an alert interface component based on the determination whether the anomaly is present in the processing component or the determination whether the data transmission matches at least one pre-identified compromised data transmission pattern.

In some embodiments, the data transmission data comprises at least one of a current data transmission data or historical data transmission data.

In some embodiments, the data transmission comprises a plurality of data transmissions and in some such embodiments, the non-transitory storage device containing instructions when executed by the processing device, causes the processing device to perform the steps of: segmenting by the machine learning model, the plurality of data transmissions and generate the data transmission based on the segmented plurality of data transmissions; and automatically blocking, based on the determination that the data transmission matches at least one pre-identified compromised data transmission, the generated data transmission.

In some embodiments, the non-transitory storage device containing instructions when executed by the processing device, causes the processing device to perform the steps of: triggering an automatic transmission of the alert interface component to a user device, wherein the user device is associated with at least one of a user account associated with the data transmission or associated with at least one entity account associated with the processing component. In some embodiments, the alert interface component comprises an alert indicating the data transmission was transmitted or automatically blocked.

In some embodiments, the non-transitory storage device containing instructions when executed by the processing device, causes the processing device to perform the steps of: applying the data transmission and the determination that the data transmission matches at least one pre-identified compromised data transmission pattern to a smart contract; and triggering, by the smart contract, an automatic block of the data transmission.

In some embodiments, the non-transitory storage device containing instructions when executed by the processing device, causes the processing device to perform the steps of: identifying a plurality of processing components and associated current processing component resource capacity for each processing component; and transmitting each data transmission to the processing component of the plurality of processing components based on the associated current processing component resource capacity.

In some embodiments, the non-transitory storage device containing instructions when executed by the processing device, causes the processing device to perform the steps of: transmitting the data transmission to a recipient account based on the determination to transmit the data transmission in an instance where the anomaly is not present in the processing component and in an instance where the data transmission does not match any of the at least one pre-identified compromised data transmission pattern.

In some embodiments, the determination of whether to transmit the data transmission further comprises an analysis, by an application engine, of a rule database and a comparison of the data transmission to the rule database.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for automatically diverting data transmission from compromised processing components, in accordance with an embodiment of the disclosure;

FIG. 2 illustrates an exemplary artificial intelligence (AI) engine subsystem architecture, in accordance with an embodiment of the disclosure

FIG. 3 illustrates an exemplary machine learning (ML) subsystem architecture, in accordance with an embodiment of the disclosure;

FIG. 4 illustrates a process flow for automatically diverting data transmission from compromised processing components, in accordance with an embodiment of the disclosure;

FIG. 5 illustrates a process flow for automatically segmenting and blocking the data transmission(s), in accordance with an embodiment of the disclosure;

FIG. 6 illustrates a process flow for triggering a smart contract to automatically block the data transmission(s), in accordance with an embodiment of the disclosure;

FIG. 7 illustrates a process flow for automatically diverting data transmission from compromised processing components, in accordance with an embodiment of the disclosure; and

FIG. 8 illustrates technical component flow diagram for automatically diverting data transmission from compromised processing components, in accordance with an embodiment of the disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this invention, a resource is typically stored in a resource repository-a storage location where one or more resources are organized, stored and retrieved electronically using a computing device.

As used herein, a “resource transfer,” “resource distribution,” “resource transmission,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e., paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated it could mean that the transaction has already occurred, is in the process of occurring or being processed, or it has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

Processing components, especially those that are configured to perform and process data transmissions to detect potential malfeasant activity or misappropriation activity within the data transmissions, can be difficult to detect whether the processing components have been compromised or are functioning improperly. Additionally, and further to this identified issue, the data transmissions intended for these processing components must be dynamically, efficiently and automatically diverted to other, valid processing components. Therefore, a need exists for a system, computer program product, or computer implemented method that can dynamically, efficiently, securely, and automatically determine whether a processing component has been compromised and divert data transmissions without allowing for the breach of the data within those data transmissions.

Accordingly, the disclosure provides for the identification of a processing component associated with a data transmission; the determination, by an artificial intelligence (AI) engine, of whether an anomaly is present in the processing component based on identifying at least one of central processing unit utilization, data transmission data, or a negative internet protocol (IP) address; the determination, by a machine learning model, whether the data transmission matches at least one pre-identified compromised data transmission pattern; and the determination of whether to transmit the data transmission based on the determination whether the anomaly is present in the processing component or the determination whether the data transmission matches at least one pre-identified compromised data transmission pattern. Additionally, the disclosure may further provide for the generation of an alert interface component based on the determination whether the anomaly is present in the processing component or the determination whether the data transmission matches at least one pre-identified compromised data transmission pattern.

In other words, the disclosure provides a system for accurately and efficiently detecting misappropriation of data transmissions and validity of misappropriation rules engines by detecting anomalies in the misappropriation rules engine based factors such as transmission types, negative IP checks, historical factors, computer utilization amounts, and/or the like. Such detection of these factors may be done by a pre-trained AI engine, which may automatically divert the data transmissions from compromised misappropriation rules engines to another validated misappropriation rules engine (e.g., that does not comprise any anomalies). Additionally, the disclosure provides a machine learning model which detects the presence of any misappropriation events or malicious activity within the data transmission(s), stops the transmission(s) in an instance where malicious activity is identified, and allows (in an instance where malicious activity is not detected) or blocks the data transmission(s) (where malicious activity is detected) from completion.

What is more, the present invention provides a technical solution to a technical problem. As described herein, the technical problem includes the determination of whether processing components are compromised and diverting data that is to be processed by those compromised processing components. The technical solution presented herein allows for the automatic determination of corrupted or compromised processing components and the automatic diversion of data transmissions from any determined corrupted processing components. In particular, the disclosure provided herein is an improvement over existing solutions to the determination of compromised processing components and the diversion of data transmissions from those corrupted processing components (and/or prior to sending data transmissions to potentially corrupted processing components), (i) with fewer steps to achieve the solution, thus reducing the amount of computing resources, such as processing resources, storage resources, network resources, and/or the like, that are being used (e.g., by determining which processing components to transmit the data transmission for analysis, overburdened processing components may be avoided until they become available again); (ii) providing a more accurate solution to problem, thus reducing the number of resources required to remedy any errors made due to a less accurate solution (e.g., through the use of an AI engine and a machine learning model to each complete their own analysis, the system provides a more accurate analysis in determining whether the processing components have been compromised and whether the data transmission comprise any malicious activity); (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources (e.g., by selecting the processing component based on each processing component's current capacity). Furthermore, the technical solution described herein uses a rigorous, computerized process to perform specific tasks and/or activities that were not previously performed. In specific implementations, the technical solution bypasses a series of steps previously implemented, thus further conserving computing resources.

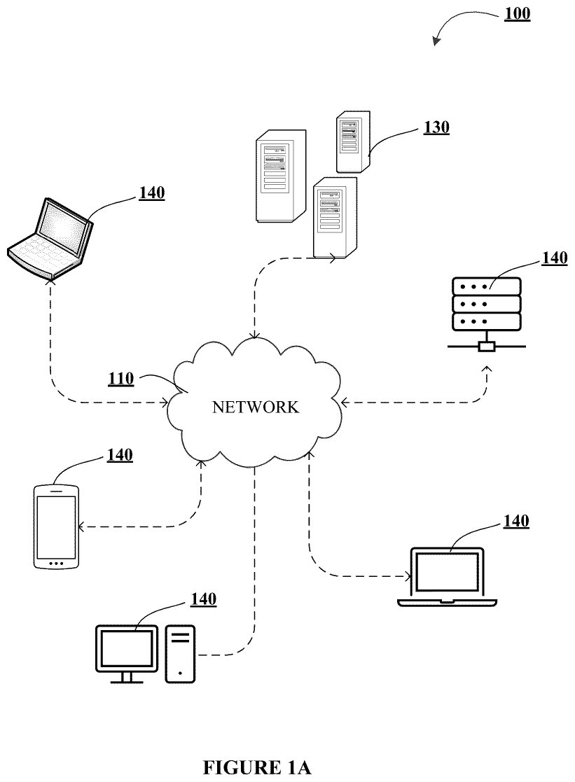

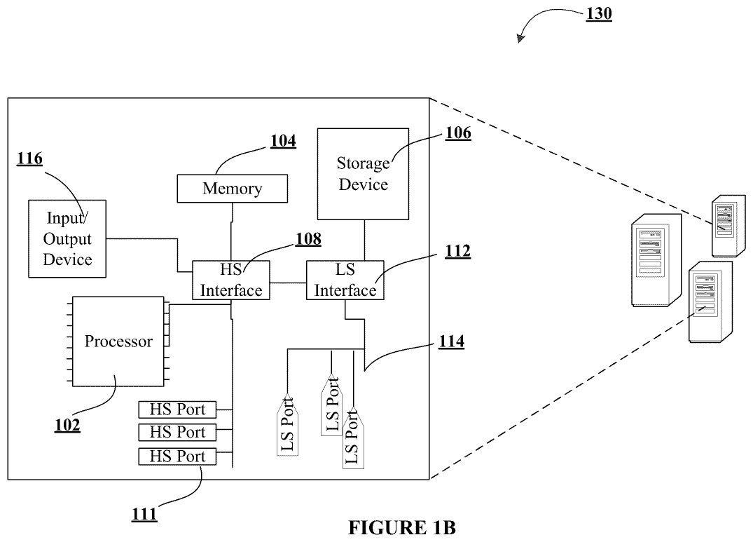

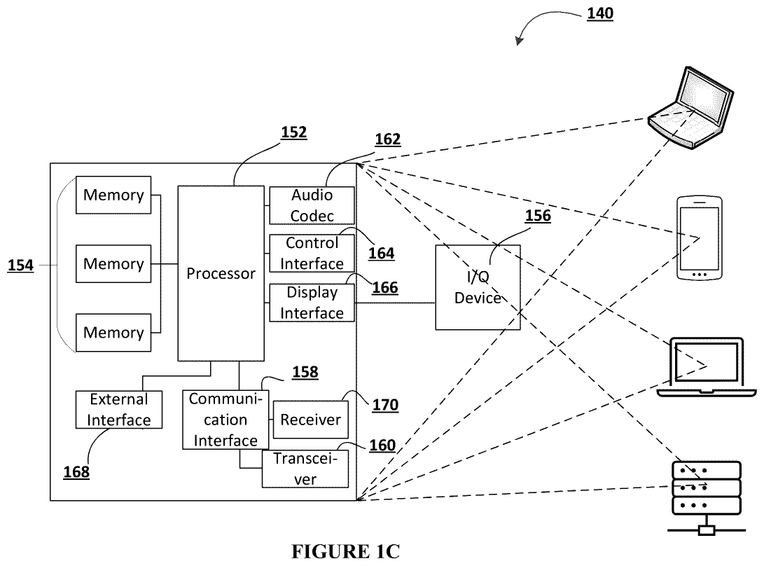

FIGS. 1A-1C illustrate technical components of an exemplary distributed computing environment for automatically diverting data transmission from compromised processing components 100, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low speed bus 114 (shown as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

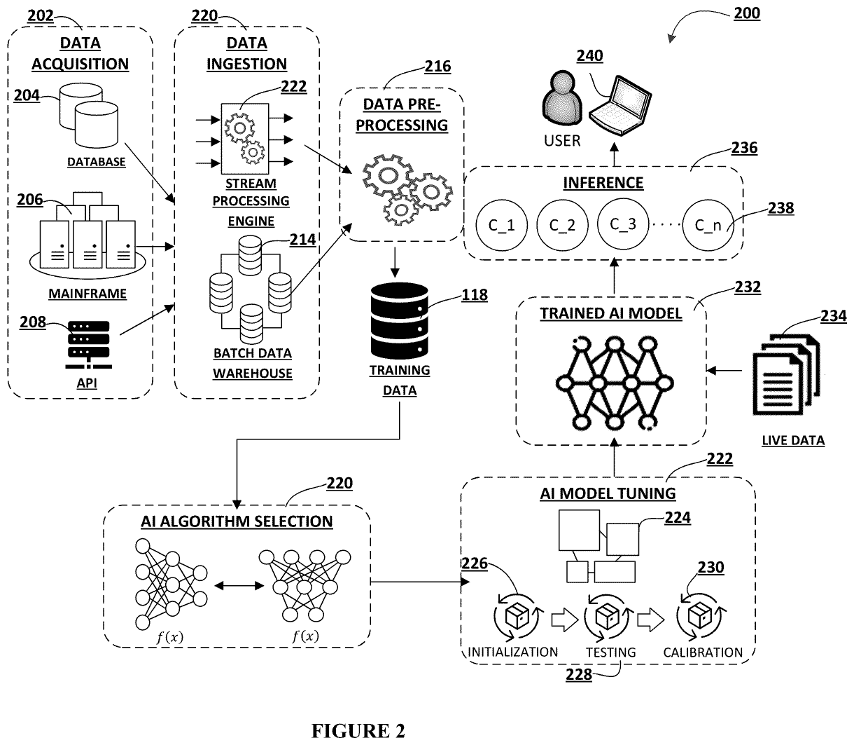

FIG. 2 illustrates an exemplary artificial intelligence (AI) engine subsystem architecture 200, in accordance with an embodiment of the disclosure. The artificial intelligence subsystem 200 may include a data acquisition engine 202, data ingestion engine 210, data pre-processing engine 216, AI engine tuning engine 222, and inference engine 236.

The data acquisition engine 202 may identify various internal and/or external data sources to generate, test, and/or integrate new features for training the artificial intelligence engine 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence engine 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so a artificial intelligence engine can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable artificial intelligence engine type. Each of these types of artificial intelligence algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the artificial intelligence engine, the AI tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the AI tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the engine is the measurement used to determine which set of hyperparameters is best at identifying relationships and patterns between variables in a dataset based on the input, or training data 218. A fully trained artificial intelligence engine 232 is one whose hyperparameters are tuned and engine accuracy maximized.

The trained artificial intelligence engine 232, similar to any other software application output, can be persisted to storage, file, memory, or application, or looped back into the processing component to be reprocessed. More often, the trained artificial intelligence engine 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence engines trained using supervised learning algorithms may be used to structure computations in terms of categorized outputs (e.g., C_1, C_2 . . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence engines trained using unsupervised learning algorithms may be used to group (e.g., C_1, C_2 . . . . C_n 238) live data 234 based on how similar they are to one another to solve exploratory challenges where little is known about the data, provide a description or label (e.g., C_1, C_2 . . . . C_n 238) to live data 234, such as in classification, and/or the like. These categorized outputs, groups (clusters), or labels are then presented to the user input system 130. In still other cases, artificial intelligence engines that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

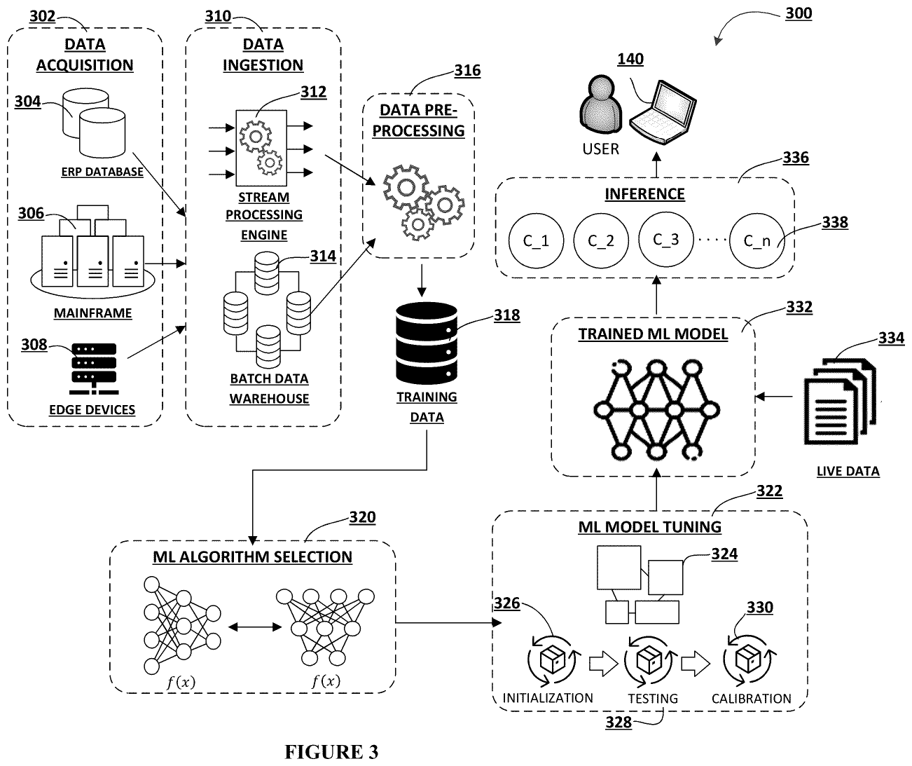

FIG. 3 illustrates an exemplary machine learning (ML) subsystem architecture 300, in accordance with an embodiment of the disclosure. The machine learning subsystem 300 may include a data acquisition engine 302, data ingestion engine 310, data pre-processing engine 316, ML model tuning engine 322, and inference engine 336.

The data acquisition engine 302 may identify various internal and/or external data sources to generate, test, and/or integrate new features for training the machine learning model 324. These internal and/or external data sources 304, 306, and 308 may be initial locations where the data originates or where physical information is first digitized. The data acquisition engine 302 may identify the location of the data and describe connection characteristics for access and retrieval of data. In some embodiments, data is transported from each data source 304, 306, or 308 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 304, 306, and 308 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 302 from these data sources 304, 306, and 308 may then be transported to the data ingestion engine 310 for further processing.

Depending on the nature of the data imported from the data acquisition engine 302, the data ingestion engine 310 may move the data to a destination for storage or further analysis. Typically, the data imported from the data acquisition engine 302 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 302, the data may be ingested in real-time, using the stream processing engine 312, in batches using the batch data warehouse 314, or a combination of both. The stream processing engine 312 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 314 collects and transfers data in batches according to scheduled intervals, trigger events, or any other logical ordering.

In machine learning, the quality of data and the useful information that can be derived therefrom directly affects the ability of the machine learning model 324 to learn. The data pre-processing engine 316 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 316 may implement feature extraction and/or selection techniques to generate training data 318. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 318 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 322 may be used to train a machine learning model 324 using the training data 318 to make predictions or decisions without explicitly being programmed to do so. The machine learning model 324 represents what was learned by the selected machine learning algorithm 320 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 322 may repeatedly execute cycles of experimentation 326, testing 328, and tuning 330 to optimize the performance of the machine learning algorithm 320 and refine the results in preparation for deployment of those results for consumption or decision making. To this end, the ML model tuning engine 322 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 318. A fully trained machine learning model 332 is one whose hyperparameters are tuned and model accuracy maximized.

The trained machine learning model 332, similar to any other software application output, can be persisted to storage, file, memory, or application, or looped back into the processing component to be reprocessed. More often, the trained machine learning model 332 is deployed into an existing production environment to make practical business decisions based on live data 334. To this end, the machine learning subsystem 300 uses the inference engine 336 to make such decisions. The type of decision-making may depend upon the type of machine learning algorithm used. For example, machine learning models trained using supervised learning algorithms may be used to structure computations in terms of categorized outputs (e.g., C_1, C_2 . . . . C_n 338) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . . C_n 338) live data 334 based on how similar they are to one another to solve exploratory challenges where little is known about the data, provide a description or label (e.g., C_1, C_2 . . . . C_n 338) to live data 334, such as in classification, and/or the like. These categorized outputs, groups (clusters), or labels are then presented to the user input system 130. In still other cases, machine learning models that perform regression techniques may use live data 334 to predict or forecast continuous outcomes.

It will be understood that the embodiment of the machine learning subsystem 300 illustrated in FIG. 3 is exemplary and that other embodiments may vary. As another example, in some embodiments, the machine learning subsystem 300 may include more, fewer, or different components.

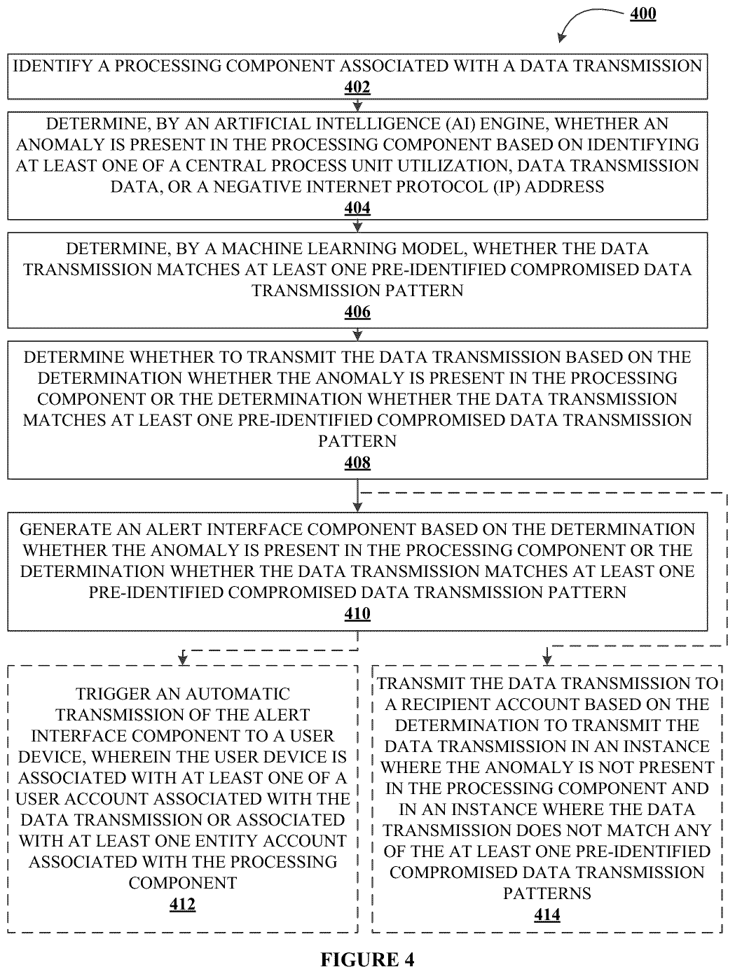

FIG. 4 illustrates a process flow 400 for automatically diverting data transmission from compromised processing components, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400. In some embodiments, an artificial intelligence engine (e.g., such as the AI engine shown in FIG. 2) and/or a machine learning model (e.g., such as the ML model shown in FIG. 3) may perform some or all of the steps described in process flow 400.

As shown in block 402, the process flow 400 may include the step of identifying a processing component associated with a data transmission. For example, and in some embodiments, the system may identify a processing component that is configured to perform a function or analysis on at least one data transmission and/or data transmission request (such as a resource transmission request). Such an analysis of the data transmission by the processing component may comprise a misappropriation attempt analysis (such that the processing component itself is a rules engine configured to detect misappropriation attempts within the data transmission and its data). In some embodiments, the system may identify at least one data transmission (such as a request for a data transmission) first, and then based on the data transmission, identify the processing component that should receive and analyze the data transmission. In some embodiments, and before transmitting the data transmission and its data to the processing component, the system may perform the process described herein to determine whether the processing component is valid and has not been corrupted. In some embodiments, and initially, the system may identify all the potential processing components that are available to receive and analyze a data transmission and may perform the analysis described herein to validate the processing component as not having been corrupted.

As used herein, the term “data transmission” refers to a packet of data (such as a packet of resource transmission data) that may be transmitted via a network from one a user device to a recipient device. Such a user device may be associated with a user account that has a resource account and intends to transmit or receive a resource transmission to or from another resource account (e.g., associated with a recipient device, such as a resource entity, a recipient resource account, and/or the like). Thus, and by way of non-limiting example, the data transmission may comprise a request to send or receive a resource transmission to and/or from a specific resource account.

As shown in block 404, the process flow 400 may include the step of determining, by an artificial intelligence (AI) engine, whether an anomaly is present in the processing component based on identifying at least one of a central processing unit (CPU) utilization, data transmission data, and/or a negative internet protocol (IP) address. For example, the system may determine—using an AI engine (similar to the one shown and described above with respect to FIG. 2)—may determine whether an anomaly (such as an indicator of a corruption or malicious rule(s)) is in the processing component(s). Thus, and in some such embodiments, the system may analyze—using the AI engine-whether the CPU utilization of the processing component (e.g., identify whether the CPU utilization is greater than it should be which may indicate the processing component is overburdened), whether the data transmission data comprises a particular transmission type that has been known to be malicious for past or historical data transmissions processed by the processing component, whether the internet protocol (IP) address associated with the processing component and/or past or historical data transmissions processed by the processing component were malicious and thus came from or was intended for a resource associated with a malicious IP address, and/or the like. Thus, and in some embodiments, the AI engine described herein, may be trained on past/historical data regarding the processing component, its data transmissions that it has processed and analyzed, and/or the like.

In some embodiments, the data transmission data comprises at least one of a current data transmission data or historical data transmission data, which is or has been analyzed and processed by the processing component. In this manner, the processing component may be validated based on the current data transmissions analyzed or historical data transmissions analyzed. Further, and based on the processing of each of these data transmissions, the system described herein, may determine whether the processing component is valid and trustworthy (or whether the processing component has been corrupted with malicious rules and/or the like).

Additionally, and in some embodiments, the AI engine used herein may comprise cognitive AI technology goes beyond normal or conventional AI engines by using a unique hybrid combination of machine learning numeric approaches alongside higher-order symbolic techniques. Such a method for this cognitive AI engine may deliver cognitive reasoning and intelligence in identifying potential anomalies in the processing component(s). For example, the AI engine described herein may be configured to assign numeric values from the training data (historical data transmissions, historical CPU utilization, historical IP addresses, and/or the like), apply the numeric training data to the AI engine and generate symbolic AI data indicating symbols, reasoning, and other such linguistic or logical data to represent the data of the AI engine. Further, and in some such embodiments, the data output by the AI engine for training may further be trained based on feedback data in the same or similar format to the symbolic data, which may be further applied back to the AI engine. In this manner, and as more data is generated by the AI engine (such as the determination regarding anomalous features/malicious features in the processing component(s)), such feedback may be collected to further train the AI engine. In some such embodiments, the feedback collected may originate from a user device (such as a user device associated with an entity managing a resource account identified in the data transmission, a user device associated with a manager of the system, a user device associated with the data transmissions (e.g., a sender and/or recipient of the data transmission), and/or the like.

As shown in block 406, the process flow 400 may include the step of determining, by a machine learning model, whether the data transmission matches at least one pre-identified compromised data transmission pattern. For example, the system may use a pre-trained machine learning model which is configured to determine whether the data transmission data is malicious or likely associated with malicious activity (such as a misappropriation attempt of resources, secure data, and/or the like, by a bad actor). Such a determination may occur based on the machine learning model's pre-training and identification of historical malicious (or misappropriation attempt) patterns in historical data transmissions.

For example, the machine learning model may be trained based on historical data transmissions that were both non-malicious (e.g., not associated with misappropriation activity) or malicious. In some embodiments, the training data may further comprise the IP addresses (e.g., recipient IP addresses and/or sender IP addresses) for each of the historical data transmissions and/or the data transmission type (e.g., where a data transmission comprises a resource transmission request of a high volume or number, this may be indicative of a potential misappropriation) for each historical data transmission, and/or the like. In some embodiments, the machine learning model may be trained on one or more of these data types (e.g., historical data transmissions (malicious and/or non-malicious), data transmission types, IP addresses, and/or the like. Additionally, and in some embodiments, the machine learning model may be trained iteratively and continuously for further refinement, such that each potential misappropriation activity and attempt is tracked and confirmed for further training, such that any new misappropriation attempts that are introduced to the system are accurately and efficiently identified without processing the data transmission. In this manner, the system-via the machine learning model and the AI engine—can accurately, efficiently, and pre-emptively determine potential malicious activity and potential corrupted processing components before processing the data transmission(s). Such a pre-emptive determination allows for the system to prevent further corruption to processing components (by preventing the processing of potentially malicious data transmission that itself could corrupt these processing components) and potential misappropriations by allowing the data transmissions to occur.

Thus, and in some embodiments, the trained machine learning model may itself generate and continuously update compromised data transmission patterns which may, in turn, be used as to compare with the current data transmission data. Further, and in some embodiments, such data transmission data analyzed and compared with the compromised data transmission pattern may additionally comprise IP address(es), CPU utilization data, and/or the like.

In some embodiments, the determination whether the data transmission matches at least one pre-identified compromised data transmission pattern may occur after the determination that the processing component is valid (i.e., not corrupted). Additionally, and/or alternatively, the determination whether the data transmission matches at least one pre-identified compromised data transmission pattern may occur at the same time as the determination that the processing component is valid (not corrupted). Additionally, and/or alternatively, the determination whether the data transmission matches at least one pre-identified compromised data transmission pattern may occur before the determination that the processing component is valid (not corrupted). In any of these embodiments, the AI engine and the machine learning model may each have their own purposes in determining whether the processing component is valid and not corrupted and can process the data transmission and whether the particular data transmission does not comprise malicious data (i.e., the determination whether the data transmission matches at least one pre-identified compromised data transmission pattern), respectively.

As shown in block 408, the process flow 400 may include the step of determining whether to transmit the data transmission based on the determination whether the anomaly is present in the processing component or the determination whether the data transmission matches at least one pre-identified compromised data transmission pattern. For example, the system may determine whether to transmit the data transmission (e.g., complete the data transmission request) based on the determination of whether an anomaly is present in the processing component and/or whether the data transmission matches at least one pre-identified compromised data transmission.

In the instance where the processing component does not have any anomalies, then the processing component may process the data transmission data to transmit the data transmission. For example, and where the data transmission comprises a resource transmission request, the processing component may comprise a rules engine that is configured to determine whether a misappropriation event is likely in the data transmission data. Thus, and where the processing component is determined to not be corrupted, the originally-identified processing component to analyze the data transmission may receive the data transmission data and perform its analysis.

However, and in an instance where the system determines that an anomaly is present in the processing component (such as over utilization of the CPU, negative IP address(es), data transmission data for historical data transmissions indicating misappropriation), then the system may automatically, dynamically, and efficiently, identify a secondary processing component that can receive and analyze the data transmission data. In some embodiments, such a secondary processing component may be pre-identified based on a listing or hierarchy of processing components. In some embodiments, the hierarchy of processing components may be based on the processing components' availability to perform the analysis on current data transmissions (e.g., where a processing component is overburdened, the processing component may be moved down in the hierarchy list). In some embodiments, such a determination may be based on current utilization (such as CPU utilization of the processing components) which are collected and read in real time by the system. In some embodiments, the determination may be based on the current utilization which is collected and read at pre-defined intervals (such as every second, every two seconds, every five seconds, and/or the like).

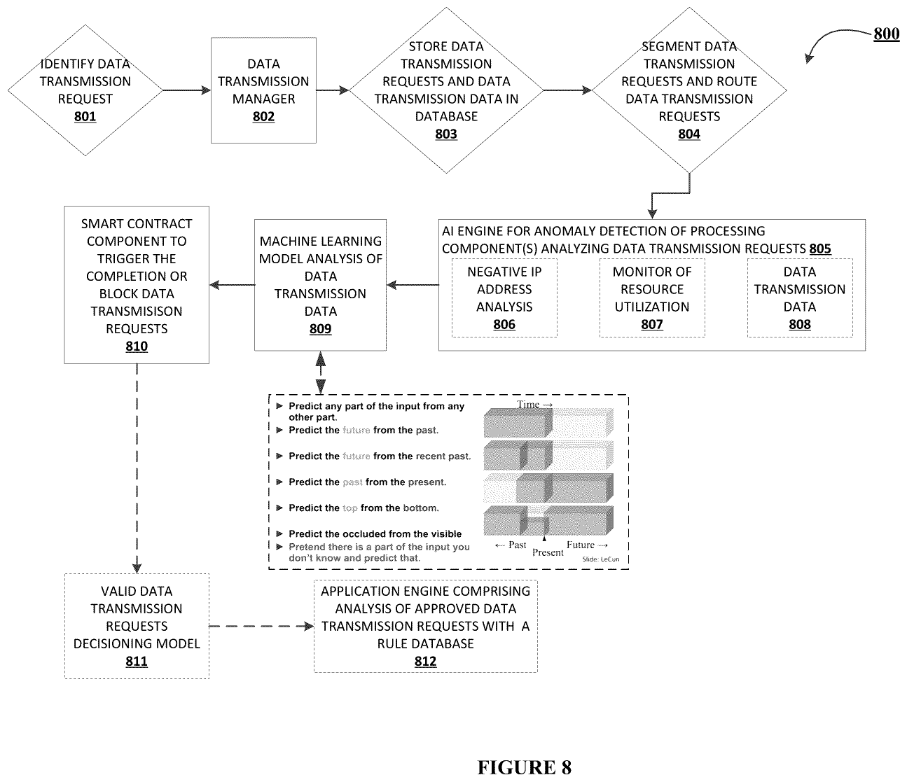

Additionally, and in some embodiments, the system may determine whether to transmit the data transmission based on the determination that the data transmission does or does not match at least one pre-identified compromised data transmission pattern. For example, the system may compare the data transmission and its data to the pre-identified compromised data transmission pattern(s) generated by the machine learning model, and where the data transmission matches at least one of the pre-identified compromised data transmission pattern(s), the system may determine the data transmission comprises a likely misappropriation/malicious event. In some embodiments, and where the data transmission is determined to comprise a misappropriation event, the system may automatically flag or block the data transmission, flag the associated IP address(es), and/or flag the data transmission type as malicious. In some embodiments, and where the data transmission is determined to not comprise a malicious event (i.e., does not match at least of the pre-identified compromised data transmission pattern(s)), then the system may continue in the performance of completing the data transmission (such as transmitting the data transmission data to its intended recipient). Additionally, and/or alternatively, the system may transmit the data transmission to an application engine for application of the data transmission data to pre-defined rules for automatic decisioning of whether to allow or block the data transmission as a final security step. For example, the determination of whether to transmit the data transmission further may further comprise an analysis, by an application engine, of a rule database and a comparison of the data transmission to the rule database. Such an embodiment is described in further detail below with respect to FIG. 8.

As shown in block 410, the process flow 400 may include the step of generating an alert interface component based on the determination whether the anomaly is present in the processing component or the determination whether the data transmission matches at least one pre-identified compromised data transmission pattern. For example, the system may determine whether the anomaly is present in the processing component and determine whether the data transmission matches at least one pre-identified comprise data transmission. For example, and in an instance where the processing component is determined to comprise an anomaly, then the system may automatically identify the another (e.g., a secondary) processing component to divert the data transmission, may perform the same process described herein to determine whether the secondary processing component comprises an anomaly and where the secondary processing component does not comprise an anomaly, automatically divert the data transmission to the secondary processing component. In contrast, and in an instance where the secondary processing component does comprise an anomaly, then the system may continue the process described herein to identify backup (such as a third, fourth, fifth, and/or the like processing components) processing components, may determine whether the backup processing components comprise an anomaly, and in an instance where the backup processing component does not, will automatically divert the data transmission for processing.

In some embodiments, the system may generate an alert interface component comprising data indicating whether the processing component(s) have been compromised (which may comprise an identifier for which processing component(s) have been compromised), whether the data transmission matches at least one pre-identified compromised data transmission pattern, and/or the like. Such data comprised within the alert interface component may be formatted in a human-readable format, such that when the alert interface component is transmitted to a user device, the user device may be automatically triggered to configure its graphical user interface (GUI) to show the data of the alert interface component.

In some embodiments, and as shown in block 412, the process flow 400 may include the step of triggering an automatic transmission of the alert interface component to a user device, wherein the user device is associated with at least one of a user account associated with the data transmission or associated with at least one entity account associated with the processing component. For example, and upon generating the alert interface component, the system may automatically transmit the generated alert interface component to at least one user device, such as but not limited to a user device associated with a user account that generated or is supposed to receive the data transmission, a user device associated with an entity that manages the resources of the data transmission, a user device associated with a manager of the system, and/or the like. In this manner, and upon receiving the alert interface component, the alert interface component may trigger the user device(s) to automatically configure their GUIs to show the data of the alert interface component.

In some embodiments, and as shown in block 414, the process flow 400 may include the step of transmitting the data transmission to a recipient account based on the determination to transmit the data transmission in an instance where the anomaly is not present in the processing component and in an instance where the data transmission does not match any of the at least one pre-identified compromised data transmission patterns. For example, and in some embodiments, the system may automatically transmit or complete the data transmission to its intended recipient (e.g., an intended recipient account, resource account, user device, and/or the like), whereby the intended recipient is determined based on the data within the data transmission. Thus, and in some such embodiments, the automatic transmission of the data transmission may occur directly after the process described herein with respect to block 408, wherein the system has determined that the processing component chosen to analyze the data transmission comprises no anomalies and the system has determined that the data transmission does not match any of the pre-identified compromised data transmission patterns generated by the machine learning model.

In some embodiments, and upon transmitting the data transmission to the intended recipient, the system may generate the alert interface component of block 410 with the details of when the data transmission was transmitted/completed (which may comprise a timestamp for completion). Thus, and in some embodiments, upon completing the process of block 414, the process described herein may continue to block 410 to generate the alert interface component. Additionally, and in some such embodiments, upon generating the alert interface component of block 410, the system may continue to block 412 and transmit the alert interface component to a user device, such as a user device associated with the sender of the data transmission, a user device of the recipient of the data transmission, a user device of a manager of a resource account associated with the data transmission, a user device of the manager of the system, and/or the like.

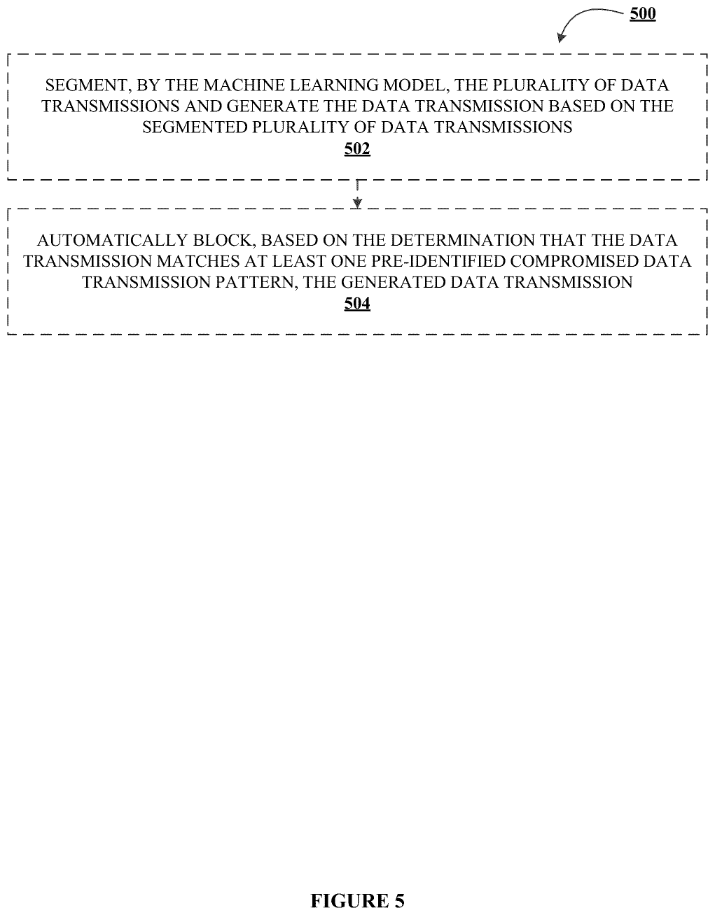

FIG. 5 illustrates a process flow 500 for automatically segmenting and blocking the data transmission(s), in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500. In some embodiments, an artificial intelligence engine (e.g., such as the AI engine shown in FIG. 2) and/or a machine learning model (e.g., such as the ML model shown in FIG. 3) may perform some or all of the steps described in process flow 500.

In some embodiments, and as shown in block 502, the process flow 500 may include the step of segmenting, by the machine learning model, the plurality of data transmissions and generating the data transmissions based on the segmented plurality of data transmissions. For example, and in some such embodiments, the data transmission may comprise a plurality of data transmissions. Thus, and in some such embodiments, where the data transmission comprises a plurality of data transmission identified and/or collected at the same time or near the same time by the system, then the system may need to segment and break up the data transmissions into their respective datasets in order to analyze each fully and concisely. Thus, and in some such embodiments, the machine learning model described herein with respect to FIGS. 3 and 4 may segment the plurality of data transmissions to generate each individual data transmission, whereby each generated data transmission from the plurality of data transmissions comprises the segmented data that is associated with each data transmission (e.g., the associated sender account identifier, the associated recipient account identifier, the data being transmitted between the sender and the recipient, the timestamp of the data transmission request, and/or the like). Thus, and in some embodiments, the data transmission generated in block 502 may precede the identification of the data transmission in FIG. 4 (e.g., the generated data transmission described herein with respect to block 502 may be the same data transmission identified and used in FIG. 4). Therefore, and in some such embodiments, the process described herein with respect to FIG. 5 may precede some or all of the blocks described with respect to FIG. 4.

In some embodiments, the machine learning model may be trained to segment each data transmission and its associated data based on identifying patterns of historical data transmissions and their associated data, which were segmented properly and/or improperly. Further, and in some embodiments, the machine learning model may be further refined and trained by applying a feedback loop for its segmentation of current data transmissions. Thus, and in some such embodiments, the machine learning model may learn from its outputs, refine its parameters to finetune its predictions, and generate more accurate future predictions of segmenting the data transmissions. Further, and in some embodiments where data transmissions start to comprise more data in their datasets, the machine learning model may train itself to identify these changing data transmission sizes and may accurately, dynamically, and efficiently segment these data transmissions based on the machine learning model's up-to-date training.

In some embodiments, and as shown in block 504, the process flow 500 may include the step of automatically blocking, based on the determination that the data transmission matches at least one pre-identified compromised data transmission pattern, the generated data transmission. For example, and in some such embodiments, the system may apply the data transmission (such as the data transmission identified in FIG. 4 and/or the data transmission generated in FIG. 5) to the machine learning model, such that the machine learning model can determine whether the data transmission matches at least one pre-identified compromise data transmission pattern. Thus, and in the instance where the data transmission does match at least one pre-identified compromised data transmission pattern, the system may automatically block the generated data transmission from completion or transmission. However, and in an instance where the data transmission does not match any of the pre-identified compromised data transmission patterns, the system may automatically allow the completion/transmission of the data transmission. In such embodiments, and as described above, the system may additionally require that the processing component analyzing the data transmission will need to be pre-validated as not comprising an anomaly before the data transmission can be completed or transmitted.

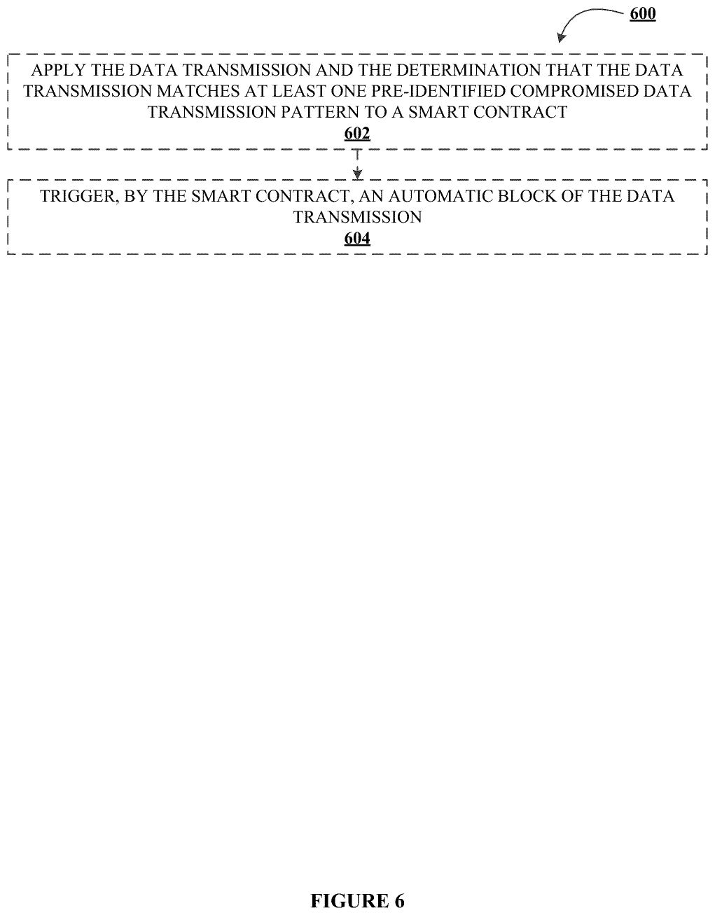

FIG. 6 illustrates a process flow 600 for triggering a smart contract to automatically block the data transmission(s), in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIG. 1A-1C) may perform the steps of process 600. In some embodiments, an artificial intelligence engine (e.g., such as the AI engine shown in FIG. 2) and/or a machine learning model (e.g., such as the ML model shown in FIG. 3) may perform some or all of the steps described in process flow 600.

In some embodiments, and as shown in block 602, the process flow 600 may include the step of applying the data transmission and the determination that the data transmission matches at least one pre-identified compromised data transmission pattern to a smart contract. For example, and in some such embodiments, the system may apply the data transmission identified and/or generated to a trained machine learning model that is configured to determine whether the data transmission matches at least one pre-identified compromise data transmission pattern.

In some embodiments, the machine learning model may be trained and configured to generate a confidence score for matching the data transmission and its data to at least one pre-identified compromised data transmission pattern, whereby the higher the confidence score, the closer the data matches between the data transmission and at least one pre-identified compromised data transmission pattern. Further, and in some such embodiments, the machine learning model may compare the generated confidence score against a confidence threshold (which may be pre-generated and updated regularly based on historical data transmission determinations and received feedback on whether they do or do not comprise potential malicious events). Such a confidence score, when compared to the confidence threshold may indicate that the data transmission is likely a match with a pre-identified compromised data transmission pattern when the confidence score meets or exceeds the confidence threshold. In an embodiment where the confidence score does not meet or exceed the confidence threshold, then the system—via the machine learning model—may determine that the data transmission does not match any of the pre-identified compromised data transmission patterns.

Further, and upon determining whether the data transmission matches at least one of the pre-identified compromised data transmission patterns, the system may trigger a smart contract that is configured to either automatically complete the data transmission or automatically block or flag the data transmission as likely malicious. Thus, and in some embodiments, based on the confidence score comparison with the confidence threshold, the smart contract may automatically trigger the allowance of the data transmission (e.g., where the confidence score does not meet or exceed the confidence threshold) or the blocking/flagging of the data transmission (e.g., where the confidence score does meet or exceed the confidence threshold).

In some embodiments, and as shown in block 604, the process flow 600 may include the step of triggering, by the smart contract, an automatic block of the data transmission. For example, and in some such embodiments, the system may trigger—using the smart contract—an automatic block of the data transmission based on the determination that the data transmission comprises potential malicious or misappropriating events. Further, and in some embodiments, the smart contract may be configured with various rules generated by the manager of a resource account at issue within the data transmission, the manager of the system, and/or the like, with rules for blocking the data transmission and diverting the data of the data transmission to a secondary or reviewing entity for further analysis. In this manner, the smart contract may act as a secondary security measure for protecting the data transmission from completion, while also ensuring that the data transmission is confirmed secondarily as malicious.

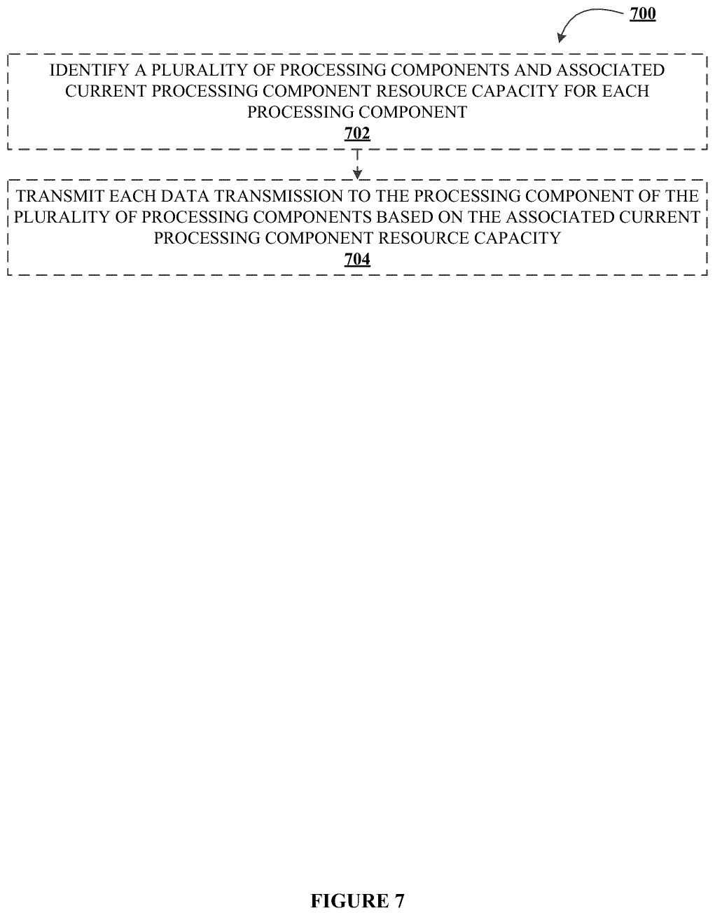

FIG. 7 illustrates a process flow 700 for transmitting each data transmission to a processing component, in accordance with an embodiment of the disclosure. In some embodiments, a system (e.g., similar to one or more of the systems described herein with respect to FIGS. 1A-1C) may perform one or more of the steps of process flow 700. For example, a system (e.g., the system 130 described herein with respect to FIG. 1A-1C) may perform the steps of process 700. In some embodiments, an artificial intelligence engine (e.g., such as the AI engine shown in FIG. 2) and/or a machine learning model (e.g., such as the ML model shown in FIG. 3) may perform some or all of the steps described in process flow 700.

In some embodiments, and as shown in block 702, the process flow 700 may include the step of identifying a plurality of processing components and associated current processing component resource capacity for each processing component. For example, and in some embodiments, the system may identify a plurality of potential processing components that could receive and analyze at least one data transmission (or a plurality of data transmission). Such an identification of potential processing components may be filtered out by the system for receiving the data transmission(s) based on their current performance capacity (e.g., current CPU utilization, current queue of data transmissions to analyze, current availability (e.g., is the processing component on and available) and/or nearest availability (such as based on a current queue of data transmissions to analyze), and/or the like.

Thus, and in some embodiments, the system may analyze each of these factors for each available processing component and may identify the current processing component resource capacity for each processing component, whereby the current processing component resource capacity is based on each of these factors. For instance, where a potential processing component is currently on, has the shortest queue for current data transmissions to process and analyze, has low CPU utilization (i.e., is not overburdened), and/or the like, then the current processing component resource capacity will likely be higher than another potential processing component that is on, has a slightly longer queue for current data transmission to process and analyze, and has a slightly higher CPU utilization. Thus, and in some such embodiments, the system may identify a potential processing component to transmit a data transmission to that has the highest current processing component resource capacity. In some embodiments, and where the primary (or originally) selected processing component comprises an anomaly, then the system may select the next processing component with the next highest current processing component resource capacity to receive the data transmission.

In some embodiments, and as shown in block 704, the process flow 700 may include the step of transmitting each data transmission to the processing component of the plurality of processing components based on the associated current processing component resource capacity. For instance, and in some embodiments, the system may determine which processing component should receive the data transmission to perform its analysis and then may automatically transmit the data transmission to the processing component based on identifying the highest current processing component capacity (or next highest based on an identification of an anomaly, or the third highest, and/or the like). Thus, and as understood by a person of skill in the art, the process of selecting a queue or hierarchy of potential processing components may occur regularly and continuously until a processing component that is validated (does not comprise an anomaly) and can handle the data transmission is selected to receive the data transmission.

FIG. 8 illustrates technical component flow diagram 800 for automatically diverting data transmission from compromised processing components, in accordance with an embodiment of the disclosure. In some embodiments, a system (e.g., similar to one or more of the systems described herein with respect to FIGS. 1A-1C) may perform one or more of the steps of the technical component flow diagram 800. For example, a system (e.g., the system 130 described herein with respect to FIG. 1A-1C) may perform the steps the technical component flow diagram 800. In some embodiments, an artificial intelligence engine (e.g., such as the AI engine shown in FIG. 2) and/or a machine learning model (e.g., such as the ML model shown in FIG. 3) may perform some or all of the steps described in the technical component flow diagram 800.

As shown in technical component flow diagram 800, the flow diagram 800 may comprise a step of identifying a data transmission request 801 (or, in some embodiments, a plurality of data transmission requests which may be segmented to generate the data transmission request with its associated and individualized data) for analysis and processing by a processing component. As used herein, the term “data transmission request” and “data transmission” may be used interchangeably to refer to a packet of data being transmitted between a sender device and a recipient device or a sender account and a recipient account, whereby the data transmission and data transmission request comprises the information for completing the transmission of the data within the data transmission. In some embodiments, the data transmission and data transmission request may comprise a resource transmission or resource distribution request, which may need to be analyzed by a rules engine configured to determine whether the resource transmission request and its data comprises any malicious or misappropriation data which could lead to the misappropriation of resources or secure data if allowed to be transmitted.

Further, and upon identifying the data transmission request, the diagram flow may continue to a data transmission manager 802 which may be configured to manage all the incoming data transmissions and ensure that all the relevant properties and data for each data transmission are stored in the database system 803. For example, and using the data transmission manager, the system may store data transmission requests and data transmission data in database 803 for future analysis and use. Additionally, and as shown in flow diagram 800, the system may segment the data transmission requests and route the data transmission requests and associated data to an AI engine configured for anomaly detection of processing component(s) that are analyzing data transmission requests 805. In some such embodiments, the AI engine 805 may base its analysis on at least on of a negative IP address analysis 806, a monitoring of resource utilization 807 (e.g., CPU utilization), an analysis of the data transmission data 808 (e.g., data transmission type, amount, and/or the like), and/or the like. Based on the analysis by the AI engine, the processing component(s) may be determined as comprising at least one anomaly or comprising no anomalies. Additionally, and in some embodiments, the use of the AI engine to determine the proper processing components to receive and analyze the data transmission may be used as a primary method of security and validation for the data transmission that is validated and analyzed by the processing component for malicious activity. Thus, and in an instance where the processing component determines that there is not any malicious activity within the data transmission, then the machine learning model of block 809 may act as a secondary or backup analysis component to confirm the outcome of the processing component based on its own individual analysis.

Thus, and in an instance where the processing component comprises no anomalies, then the flow diagram 800 may continue to the machine learning model analysis of the data transmission data 809, which may comprise an analysis of the data transmission request data to determine whether a misappropriation or malicious event is likely present in the data. In some embodiments, and where data is missing in the properties of the data transmission request, then the machine learning model—based on its extensive training—may fill in any missing or blank data fields, which may be based on its historical data analyses, the present data in the data transmission data, and/or the like.

Additionally, and upon confirming that the data transmission does not comprise any malicious or misappropriation event data, then the system may continue by applying the determination of whether the malicious or misappropriation data is present in the data transmission to a smart contract component, whereby the smart contract component may trigger the completion of or bock the data transmission request 810. Additionally, and in some embodiments, the flow diagram 800 may continue to validate the data transmission requests using a decisioning model 811, whereby the decisioning model may be configured to determine whether any further actions should be taken for the data transmission request (such as a further analysis by a manager of an account associated with the data transmission request), a further analysis based on rules associated with an entity of the data transmission request, and/or the like. In some embodiments, the system may further comprise an application engine comprising an analysis of approved data transmission requests (validated data transmissions requests) with a rule database, such as a rule database managed and updated by an entity associated with the data transmission (e.g., an entity associated with a resource account identified in the data transmission request), and/or the like. In some such embodiments, the rule database may comprise rules regarding which reviewing user accounts should receive the approved data transmission for an additional layer of security and validation.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for automatically diverting data transmissions from compromised processing components, the system comprising:
a processing device;
a non-transitory storage device containing instructions when executed by the processing device, causes the processing device to perform the steps of:
identify a processing component associated with a data transmission;
determine, by an artificial intelligence (AI) engine, whether an anomaly is present in the processing component based on identifying at least one of central processing unit utilization, data transmission data, or a negative internet protocol (IP) address;
determine, by a machine learning model, whether the data transmission matches at least one pre-identified compromised data transmission pattern;
determine whether to transmit the data transmission based on the determination whether the anomaly is present in the processing component or the determination whether the data transmission matches at least one pre-identified compromised data transmission pattern; and
generate an alert interface component based on the determination whether the anomaly is present in the processing component or the determination whether the data transmission matches at least one pre-identified compromised data transmission pattern.

2. The system of claim 1, wherein the data transmission data comprises at least one of a current data transmission data or historical data transmission data.

3. The system of claim 1, wherein the data transmission comprises a plurality of data transmissions, and wherein the non-transitory storage device containing instructions when executed by the processing device, causes the processing device to perform the steps of:
segment, by the machine learning model, the plurality of data transmissions and generate the data transmission based on the segmented plurality of data transmissions; and
automatically block, based on the determination that the data transmission matches at least one pre-identified compromised data transmission, the generated data transmission.

4. The system of claim 1, wherein the non-transitory storage device containing instructions when executed by the processing device, causes the processing device to perform the steps of:
trigger an automatic transmission of the alert interface component to a user device, wherein the user device is associated with at least one of a user account associated with the data transmission or associated with at least one entity account associated with the processing component.

5. The system of claim 4, wherein the alert interface component comprises an alert indicating the data transmission was transmitted or automatically blocked.

6. The system of claim 1, wherein the non-transitory storage device containing instructions when executed by the processing device, causes the processing device to perform the steps of:
apply the data transmission and the determination that the data transmission matches at least one pre-identified compromised data transmission pattern to a smart contract; and
trigger, by the smart contract, an automatic block of the data transmission.

7. The system of claim 1, wherein the non-transitory storage device containing instructions when executed by the processing device, causes the processing device to perform the steps of:
identify a plurality of processing components and associated current processing component resource capacity for each processing component; and
transmit each data transmission to the processing component of the plurality of processing components based on the associated current processing component resource capacity.

8. The system of claim 1, wherein the non-transitory storage device containing instructions when executed by the processing device, causes the processing device to perform the steps of:
transmit the data transmission to a recipient account based on the determination to transmit the data transmission in an instance where the anomaly is not present in the processing component and in an instance where the data transmission does not match any of the at least one pre-identified compromised data transmission pattern.

9. The system of claim 1, wherein the determination of whether to transmit the data transmission further comprises an analysis, by an application engine, of a rule database and a comparison of the data transmission to the rule database.

10. A computer program product for automatically diverting data transmissions from compromised processing components, the computer program product comprising a non-transitory computer-readable medium comprising code causing an apparatus to:
identify a processing component associated with a data transmission;
determine, by an artificial intelligence (AI) engine, whether an anomaly is present in the processing component based on identifying at least one of central processing unit utilization, data transmission data, or a negative internet protocol (IP) address;
determine, by a machine learning model, whether the data transmission matches at least one pre-identified compromised data transmission pattern;
determine whether to transmit the data transmission based on the determination whether the anomaly is present in the processing component or the determination whether the data transmission matches at least one pre-identified compromised data transmission pattern; and
generate an alert interface component based on the determination that the anomaly is present in the processing component or the determination that the data transmission matches at least one pre-identified compromised data transmission pattern.

11. The computer program product of claim 10, wherein the data transmission data comprises at least one of a current data transmission data or historical data transmission data.

12. The computer program product of claim 10, wherein the data transmission comprises a plurality of data transmissions, and the computer program product further comprising non-transitory computer-readable medium comprising code causing an apparatus to:
segment, by the machine learning model, the plurality of data transmissions and generate the data transmission based on the segmented plurality of data transmissions; and
automatically block, based on the determination that the data transmission matches at least one pre-identified compromised data transmission, the generated data transmission.

13. The computer program product of claim 10, the computer program product further comprising non-transitory computer-readable medium comprising code causing an apparatus to:
trigger an automatic transmission of the alert interface component to a user device, wherein the user device is associated with at least one of a user account associated with the data transmission or associated with at least one entity account associated with the processing component.

14. The computer program product of claim 13, wherein the alert interface component comprises an alert indicating the data transmission was transmitted or automatically blocked.

15. The computer program product of claim 10, the computer program product further comprising non-transitory computer-readable medium comprising code causing an apparatus to:
apply the data transmission and the determination that the data transmission matches at least one pre-identified compromised data transmission pattern to a smart contract; and
trigger, by the smart contract, an automatic block of the data transmission.

16. A computer implemented method for automatically diverting data transmissions from compromised processing components, the computer implemented method comprising:
identifying a processing component associated with a data transmission;
determining, by an artificial intelligence (AI) engine, whether an anomaly is present in the processing component based on identifying at least one of central processing unit utilization, data transmission data, or a negative internet protocol (IP) address;
determining, by a machine learning model, whether the data transmission matches at least one pre-identified compromised data transmission pattern;
determining whether to transmit the data transmission based on the determination that the anomaly is present in the processing component or the determination that the data transmission matches at least one pre-identified compromised data transmission pattern; and
generating an alert interface component based on the determination whether the anomaly is present in the processing component or the determination whether the data transmission matches at least one pre-identified compromised data transmission pattern.

17. The computer implemented method of claim 16, wherein the data transmission data comprises at least one of a current data transmission data or historical data transmission data.

18. The computer implemented method of claim 16, wherein the data transmission comprises a plurality of data transmissions, further comprising:
segmenting, by the machine learning model, the plurality of data transmissions and generate the data transmission based on the segmented plurality of data transmissions; and
automatically blocking, based on the determination that the data transmission matches at least one pre-identified compromised data transmission, the generated data transmission.

19. The computer implemented method of claim 16, further comprising:
triggering an automatic transmission of the alert interface component to a user device, wherein the user device is associated with at least one of a user account associated with the data transmission or associated with at least one entity account associated with the processing component.

20. The computer implemented method of claim 19, wherein the alert interface component comprises an alert indicating the data transmission was transmitted or automatically blocked.
